(19) United States
(12) Patent Application Publication
(10) Pub. No.: US 2006/0046657 A1
(43) Pub. Date: Mar. 2, 2006

(54) Diversity receiver and method for estimating signal quality

(76) Inventor: Hendricus Clemens De Ruijter, Hilversum (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,684

(22) PCT Filed: Apr. 29, 2003
(86) PCT No.: PCT/IB03/01736

§ 371 Date: Nov. 24, 2004

(30) Foreign Application Priority Data
May 28, 2002 (EP) 02077084.8

(51) Int. Cl. H04B 17/00

(52) U.S. Cl. 455/67.11; 455/226.1

(57) ABSTRACT

Receivers (1,11) like mobile or cordless terminals and mobile or cordless base stations for receiving signals and comprising decision takers (2,12) for taking decisions like selecting antennas in antenna diversity systems (3) or like selecting channels to be used for communication (13) or like synchronisation decisions for synchronisation purposes are improved by providing them with wave analysers (4,14) for analysing at least a part—like a preamble or a pilot—of the received signal and for in response to analysis results supplying control signals to the decision takers (2,12). Such wave analysers (4,14) provide the receivers (1,11) with better quality indicators compared to prior art signal strength indicators and comprise delaying stages (20) for generating control signals representing DC jitter, comparing stages (40) for generating further control signals representing a presence of a non-part-frequency like presences of higher frequencies and lower frequencies, and data slicing stages (70) for generating sliced bits.

The invention relates to a receiver for receiving a signal and comprising a decision taker for taking a decision.

The invention also relates to a wave analyser for use in a receiver for receiving a signal and comprising a decision taker for taking a decision, and to a method comprising the steps of receiving a signal and of taking a decision, and to a processor program product to be run via a processor.

Such a receiver for example corresponds with a mobile phone or a cordless phone or a base station for mobile communication or a base station for cordless communication and/or forms part of a transceiver.

A prior art receiver is known from U.S. Pat. No. 5,952,963, which discloses a receiver in the form of a base station comprising a plurality of antennas each receiving a signal. A decision taker in the form of a preamble diversity switching circuit measures the signal strengths and comprises a comparator for comparing signal strength indicators and in response selecting the antenna which provides the highest signal strength indicator.

However, other decision takers are not to be excluded, like selectors for selecting a radio channel to be used by said receiver or like synchronisers for synchronising the receiver to the received signal etc.

The known receiver is disadvantageous, inter alia, due to said signal strength indicators not always being reliable quality indicators, for example in environments with excessive multipath fading.

It is an object of the invention, inter alia, of providing a receiver as defined above in which said decision taker is provided with more reliable quality indicators.

The receiver according to the invention is characterised in that said receiver comprises a wave analyser for analysing at least a part of the received signal and for in response to an analysis result supplying at least one control signal to said decision taker.

Said wave analyser will, compared to measured signal strength indicators, provide the receiver with better quality indicators. Said part for example corresponds with a (predefined) preamble signal or with a (predefined) pilot signal.

The invention is based upon an insight, inter alia, that signal strength indicators give a one-sided view of the received signal, and is based upon a basic idea, inter alia, that a wave analysis will give a more allround indication.

The invention solves the problem, inter alia, of improving the receiver by letting the wave analyser generate more reliable quality indicators, and is advantageous, inter alia, in that the decision taking process is improved.

A first embodiment of the receiver according to the invention as defined in claim 2 is advantageous in that said wave analyser comprises a delaying stage for generating said control signal representing a DC jitter.

Said delaying stage allows different samples of the received signal to be used for estimating the DC jitter.

A second embodiment of the receiver according to the invention as defined in claim 3 is advantageous in that said delaying stage adds samples of the received signal and subtracts samples of adding results for generating said control signal.

Said adding defines the first time-interval (for example one preamble bit or half a preamble period) of the received signal for which the DC is estimated. Said subtracting defines the second time-interval (for example one/eighth of a preamble bit or one/sixteenth of a preamble period) for which the DC jitter is estimated.

A third embodiment of the receiver according to the invention as defined in claim 4 is advantageous in that said wave analyser comprises a comparing stage for generating a further control signal representing a presence of a non-part-frequency.

Said comparing stage allows different samples of the received signal to be compared with each other for estimating the presence of frequencies other than said part-frequency. Said part-frequency for example corresponds with a preamble frequency or a pilot frequency.

A fourth embodiment of the receiver according to the invention as defined in claim 5 is advantageous in that said comparing stage compares samples of the received signal and processes comparison results and adds processing results for generating two further control signals representing a presence of a lower frequency and a higher frequency than said part-frequency.

Said presences of the lower frequency and of the higher frequency, in addition with said DC jitter, give a good quality estimation of the received signal.

A fifth embodiment of the receiver according to the invention as defined in claim 6 is advantageous in that said wave analyser comprises a data slicing stage for generating sliced bits.

Said data slicing stage for generating sliced bits also uses the delaying stage, which delaying stage is now used for quality estimation as well as for bit generation, which makes the receiver more efficient.

A sixth embodiment of the receiver according to the invention as defined in claim 7 is advantageous in that said data slicing stage filters said added samples of said received signal and compares a filtering result with a sample of said demodulated signal for generating said sliced bits.

Said filtering for example corresponds with recursive low pass filtering to which a freeze-slow-fast slice amplifier has been added.

Embodiments of the wave analyser according to the invention, of the method according to the invention and of the processor program product according to the invention correspond with the embodiments of the receiver according to the invention.

These and other aspects of the invention will be apparent from and elucidated with reference to the embodiments(s) described hereinafter.

FIG. 1 illustrates in block diagram form a receiver according to the invention comprising a wave analyser according to the invention,

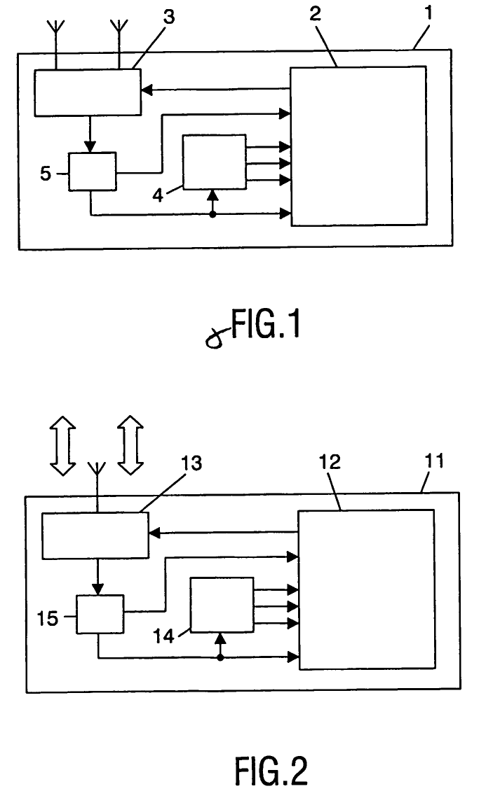

FIG. 2 illustrates in block diagram form a further receiver according to the invention comprising a wave analyser according to the invention, and

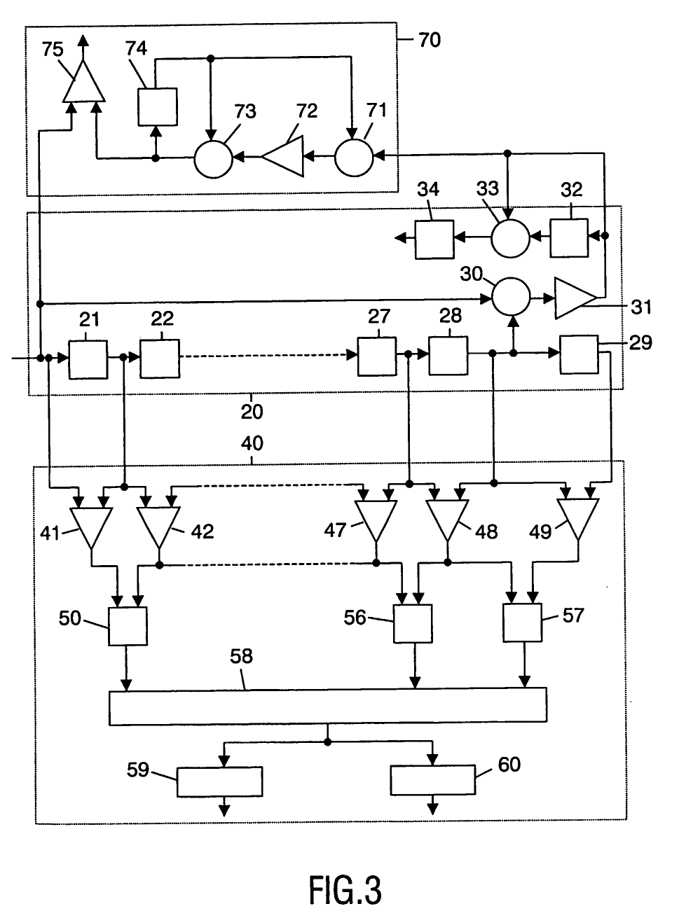

FIG. 3 illustrates in block diagram a wave analyser according to the invention in detail.

The receiver 1 shown in FIG. 1 comprises a decision taker 2 of which an output is coupled to an input of an antenna switch 3 and of which inputs are coupled to outputs of a wave analyser 4 and to an output of a demodulator 5 and to a control output of demodulator 5. Said output of demodulator 5 is further coupled to an input of wave analyser 4, and an input of demodulator 5 is coupled to an output of antenna switch 3.

The receiver 11 shown in FIG. 2 comprises a decision taker 12 of which an output is coupled to an input of a channel selector 13 and of which inputs are coupled to outputs of a wave analyser 14 and to an output of a demodulator 15 and to a control output of demodulator 15. Said output of demodulator 15 is further coupled to an input of wave analyser 14, and an input of demodulator 15 is coupled to an output of channel selector 13.

Wave analyser 4,14 shown in more detail in FIG. 3 comprises a delaying stage 20, a comparing stage 40 and a data slicing stage 70. Delaying stage 20 comprises nine delaying elements 21-29 coupled serially, with an input of delaying element 21 being the input of the wave analyser coupled to demodulator 5,15. An output of delaying element 28 is further coupled to an input of an adder 30, of which a further input is coupled to said input of said wave analyser. An output of adder 30 is coupled to an input of an amplifier 31, of which an output is coupled to a delaying element 32 and to an input of a subtractor 33, of which a further input is coupled to an output of said delaying element 32 and of which an output is coupled to an input of an absolute-value-circuit 34, which generates a control signal representing a DC jitter to be supplied to decision taker 2,12.

Comparing stage 40 comprises nine comparators 41-49, each one having two inputs coupled to the input and the output of a corresponding delaying element 21-29. The outputs of each subsequent pair of comparators 41-49 form the inputs of EXOR gates 50-57, of which the outputs are coupled to inputs of an adder 58, of which an output is coupled to inputs of detectors 59 and 60, which generate further control signals representing a presence of a higher and a lower frequency than a preamble frequency.

Data slicing stage 70 comprises a subtractor 71 of which an input is coupled to the output of amplifier 31 and of which an output is coupled to an input of a freeze-slow-fast slice amplifier 72, of which an output is coupled to an input of an adder 73, of which an output is coupled to an input of a delaying element 74 and to an input of a comparator 75, of which a further input is coupled to said input of said wave analyser. Comparator 75 generates sliced bits. An output of delaying element 74 is coupled to further inputs of subtractor 71 and of adder 73.

Wave analyser 4,14 as shown more detailledly in FIG. 3 functions as follows. A signal comprising for example a part in the form of an n-bits preamble (DECT: 16 bits, with a bitstream of 1152 kbit/s and a part-frequency or preamble frequency of 567 KHz) and further comprising for example a sync word and for example a data field is received via antenna switch 3 or channel selector 13 and demodulated via demodulator 5,15. As a result, the preamble in the form of a sine wave is generated, which is analysed by wave analyser 4,14. Thereto, wave analyser 4,14 comprises delaying stage 20 which (over)samples this sine wave, for example eight times. The sum of delaying elements 21-28 for example corresponds with half a part-period or preamble period. In case the input signal for delaying element 21 is x(n), the output signal for delaying element 28 is x(n−8). Amplifier 31 for example amplifies the output signal of adder 30 with a factor 0.5, and the absolute-value-circuit 34 then generates the control signal representing the DC jitter: DCjitter (n−9)=ABS[0.5{(x(n)+x(n−8))−(x(n−1)+x(n−9))}].

This control signal is supplied to decision taker 2,12 in the form of a number: a higher number indicates more DC jitter and therefore a worse quality. Decision taker 2,12 can use this information for controlling antenna switch 3 for selecting another antenna or for controlling channel selector 13 for selecting and/or requesting another channel to be used or for controlling a synchroniser for adapting a synchronisation process.

Comparing stage 40 comprises comparators 4149 which detect the sign of the slope between each subsequent pair of samples. EXOR gates 50-57 detect changes in these signs, and adder 58 adds all these changes. HF detector 59 for example generates a further control signal representing the presence of higher frequencies: HF(n+1)=IF (sum(n)<2, 0, IF (sum(n)=2, 10, IF (sum(n)=3, 20, IF (sum(n)=4, 30, 40)))). This is based upon the fact that in half a wavelength the maximum number of sign changes may be one, if there are more sign changes, there are higher frequencies: a higher number indicates more HF frequencies and therefore a worse quality. LF detector 60 for example generates a further control signal representing the presence of lower frequencies: LF(n+1)=IF [ sum(n)=0, {IF (LF(n)=MAX, MAX, (LF(n)+10))}, 0]. This is based upon the fact that in half a wavelength the minimum number of sign changes is zero, and after a sign change, the next sign change must come within a predefined time-interval, if this is not the case, there are lower frequencies: a higher number indicates more LF frequencies and therefore a worse quality.

These further control signals are supplied to decision taker 2,12 in the form of numbers: a higher number indicates more HF/LF frequencies and therefore a worse quality. Decision taker 2,12 can use this information for controlling antenna switch 3 for selecting another antenna or for controlling channel selector 13 for selecting and/or requesting another channel to be used or for controlling a synchroniser for adapting a synchronisation process.

A total part-distorsion or preamble distorsion can be calculated by using three weighting functions: PDunfiltered=[Kmj×DCjitter]+[Khf×HF]+[Klf×LF], with Kmj, Khf and Klf for example being equal to one. When using a recursive digital filter, the preamble distorsion becomes: PD(n)=PD(n−1)+[PDunfiltered(n)−PD(n−1)]/Ktau, with Ktau for example being equal to twenty.

Further improvements could be situated a) in measuring the amplitude of the received signal and comparing this amplitude with a threshold, with a comparison result being a first yet further control signal, and/or b) in measuring the jitter on this amplitude, a pure preamble must have a constant amplitude, so the amplitude modulation depth can result is a second yet further control signal, and/or c) in comparing the shape of the received signal with a desirable shape, with differences between this shape and the desirable shape resulting in a third yet further control signal.

Data slicing stage 70 cooperates with a notch filter 21-28,30,31 for removing the part-frequency or preamble frequency and comprises a recursive low pass filter 71-74 for filtering any remaining noise. Due to said noth filter 21-28,30,31 coinciding with a (large) part of delaying stage 20, this wave analyser is extremely efficient and cost-friendly. Data slicing stage 70 generates sliced bits, which for example could be used for synchronisation purposes.

Each part of wave analyser 4,14 could be realised through hardware, software or a mixture of both. When realised in the form of a processor, wave analyser 4,14 and decision taker 2,12 could possibly be integrated with each other. When realised in the form of a processor program product, wave analyser 4,14 and decision taker 2,12 could possibly be integrated with each other. Usually, but not exclusively, wave analyser 4,14 will be coupled to a demodulator 5,15 for demodulating a radio signal and to a decision taker 2,12 for taking a decision with respect to said radio signal.

Delaying stage 20 comprises eight delaying elements 21-28 plus one delaying element 29 for said comparing stage 40, but an other number of delaying elements is not to be excluded. Between said input of wave analyser 4,14 and adder 30, usually there will be at least two delaying elements. In case of eight delaying elements 21-28 being used for getting a delay of half a preamble period, each delaying element will have a delay of one sixteenth of a preamble period. Preferably, one wave analyser 4,14 will be built, with an adjustable clock signal generator such that different preambles with different frequencies and periods can be dealt with. Said delaying elements, adder, subtractor, amplifier and absolute-value-circuit are just examples.

Comparing stage 40 comprises k) comparators 41-49, l) EXOR gates 50-57, m) adder 58 and n) detectors 59,60 for k) comparing samples of the received signal and l) processing comparison results and m) adding processing results for generating n) two further control signals representing a presence of a lower frequency and a higher frequency than said preamble frequency. Therefore, said comparators, EXOR gates, adder and detectors are just examples.

Other signals to be received and comprising other parts to be analysed are however not to be excluded, like for example Orthogonal Frequency Division Multiplexing signals or OFDM signals (e.g. IEEE802.11a) comprising parts in the form of pilot signals to be analysed for checking the quality of the OFDM link. Said signals comprising said parts may arrive wirelessly or wiredly and may be electrical signals or optical signals, with said optical signals then requiring optical-to-electrical conversions.

In addition to the input of decision taker 2,12 coupled to the control output of demodulator 5,15 for receiving other quality indicators like for example radio signal strength indicators for further improving the decision taking process and for getting further allround indications, a further input of decision taker 2,12 may be coupled to a further control output of for example antenna switch 3 or channel selector 13 for further receiving other quality indicators for yet further improving the decision taking process and for getting yet further allround indications.

Said processor program product to be run via a processor comprises the functions of (I) analysing at least a preamble of a received signal and of (II) in response to an analysis result generating at least one control signal to be used for taking a decision. However, many further functions could be added, like for example and without being exclusively the functions of (III) (over)sampling the sine wave, of (IV) generating the control signal representing the DC jitter, of (V) detecting the sign of the slope between each subsequent pair of samples, of (VI) detecting changes in these signs, of (VII) adding all these changes, of (VIII) generating a further control signal representing the presence of higher frequencies, of (IX) generating a further control signal representing the presence of lower frequencies, of (X) calculating a total preamble distorsion by using weighting functions, and of (XI) using a recursive digital filter for getting a filtered preamble distorsion, etc.

1. Receiver for receiving a signal and comprising a decision taker for taking a decision, characterised in that said receiver comprises a wave analyser for analysing at least a part of the received signal and for in response to an analysis result supplying at least one control signal representing a DC jitter to said decision taker.

2. Receiver according to claim 1, characterised in that said wave analyser comprises a delaying stage for generating said control signal representing a DC jitter.

3. Receiver according to claim 2, characterised in that said delaying stage adds samples of the received signal and subtracts samples of adding results for generating said control signal.

4. Receiver according to claim 2, characterised in that the DC jitter is determined for a half period section of a periodic signal.

5. Receiver according to claim 2, characterised in that said wave analyser comprises a comparing stage for generating a further control signal representing a presence of a non-part-frequency.

6. Receiver according to claim 5, characterised in that said comparing stage compares samples of the received signal and processes comparison results and adds processing results for generating two further control signals representing a presence of a lower frequency and a higher frequency than said part-frequency.

7. Receiver according to claim 3, characterised in that said wave analyser comprises a data slicing stage for generating sliced bits.

8. Receiver according to claim 7, characterised in that said data slicing stage filters said added samples of said received signal and compares a filtering result with a sample of said demodulated signal for generating said sliced bits.

9. Wave analyser for use in a receiver for receiving a signal and comprising a decision taker for taking a decision, characterised in that said wave analyser analyses at least a part of the received signal and in response to an analysis result generates at least one control signal representing a DC jitter to be supplied to said decision taker.

10. Wave analyser for use in a receiver as claimed in claim 9, characterised in that said wave analyser comprises a delaying stage for generating said control signal representing a DC jitter.

11. Method comprising the steps of receiving a signal and of taking a decision, characterised in that method comprises the steps of analysing at least a part of the received signal, determining a DC jitter based on the analysing of at least part of the received signal, generating a control signal based on the DC jitter to be used for said decision taking.

12. Processor program product to be run via a processor, characterised in that said processor program product comprises the functions of analysing at least a part of a received signal and generating a DC jitter based on the analysis, generating at least one control signal based on the DC jitter to be used for taking a decision.
